(19) United States
(12) Patent Application Publication
(10) Pub. No.: US 2016/0047165 A1
(43) Pub. Date: Feb. 18, 2016

(54) LADDER FOR MAST ASSEMBLY

(71) Applicant: PROGRESS RAIL SERVICES CORPORATION, Albertville, AL (US)

(72) Inventors: Donald A. King, Louisville, KY (US); Ryan M. Taylor, Milton, KY (US)

(73) Assignee: PROGRESS RAIL SERVICES CORPORATION, Albertville, AL (US)

(21) Appl. No.: 14/461,704

(22) Filed: Aug. 18, 2014

(51) Int. Cl. E06C 1/34; B61L 9/00; E06C 9/06

(52) U.S. Cl. CPC E06C 1/34; E06C 9/06; B61L 9/00

(57) ABSTRACT

A ladder for a mast assembly is provided. The ladder includes a frame assembly having a pair of side rails and a plurality of rungs. The ladder also includes a sub-assembly affixed to an interior facing side of the frame assembly. The sub-assembly includes a platform provided at a bottom section of the sub-assembly. The sub-assembly also includes a plurality of support rails provided at a top section of the sub-assembly. A first end of each of the support rails is pivotably coupled to the frame assembly. A second end of each of the support rails is configured to contact with the mast assembly when the ladder is in a deployed position with respect to the mast assembly. The frame assembly and the at least one sub-assembly is collapsible against the mast assembly.

### TECHNICAL FIELD

The present disclosure relates to a ladder for a mast assembly, and more specifically to a ladder for mast assembly associated with a railway signal assembly.

### BACKGROUND

Usually, a mast assembly is used for mounting signal lights, communication equipment, and so on, at a distance above ground level. The mast assembly may be provided with a ladder to allow personnel to access the mast assembly for service or maintenance purposes. In a situation when the ladder is rigidly affixed to the mast assembly, the ladder may occupy considerable space in an area surrounding the mast assembly. Such an arrangement of the ladder and the mast assembly may be undesirable in locations having space constraints. Also, due to the bulk of the ladder and the mast assembly, the transportation of the ladder and mast assembly to an installation location may be laborious. Further, due to an overall size of the ladder and the mast assembly, limited number of such assemblies may be transported in each package, thus resulting in increased transportation costs.

U.S. Pat. No. 8,397,868 describes a railway signal mast assembly. The assembly includes a signal mast and one or more signal light support arms for supporting a railway signal light on the mast. The assembly also includes a collapsible worker support cage attached to the signal mast proximate each set of signal light support arms to allow a worker to access the signal light mounted thereon for purposes of installation and maintenance. Each worker support cage includes a worker support platform and at least one side rail each pivotally attached to the signal mast and pivotal between stowed and use positions.

### SUMMARY OF THE DISCLOSURE

In one aspect of the present disclosure, a ladder for a mast assembly is provided. The ladder includes a frame assembly configured to be coupled to the mast assembly. The frame assembly includes a pair of side rails and a plurality of rungs extending between the pair of side rails. The ladder also includes at least one sub-assembly affixed to an interior facing side of the frame assembly. The at least one sub-assembly includes a platform provided at a bottom section of the sub-assembly. A first end of the platform is pivotably coupled to the frame assembly. A second end of the platform is pivotably coupled to the mast assembly. The at least one sub-assembly also includes a plurality of support rails provided at a top section of the sub-assembly. Each of the plurality of support rails are spaced apart from each other. A first end of each of the support rails is pivotably coupled to the frame assembly. A second end of each of the support rails is configured to contact with the mast assembly when the ladder is in a deployed position with respect to the mast assembly. The frame assembly and the at least one sub-assembly is collapsible against the mast assembly.

In another aspect of the present disclosure, a railway signal assembly is provided. The railway signal assembly includes a mast assembly and a ladder having an interior facing side connected to the mast assembly. The ladder includes a frame assembly configured to be coupled to the mast assembly. The frame assembly includes a pair of side rails and a plurality of rungs extending between the pair of side rails. The ladder also includes at least one sub-assembly affixed to the interior facing side. The at least one sub-assembly includes a platform provided at a bottom section of the sub-assembly. A first end of the platform is pivotably coupled to the frame assembly. A second end of the platform is pivotably coupled to the mast assembly. The at least one sub-assembly also includes a plurality of support rails provided at a top section of the sub-assembly. Each of the plurality of support rails is spaced apart from each other. A first end of each of the support rails is pivotably coupled to the frame assembly. A second end of each of the support rails is configured to contact with the mast assembly when the ladder is in a deployed position with respect to the mast assembly. The frame assembly and the at least one sub-assembly is collapsible against the mast assembly.

Other features and aspects of this disclosure will be apparent from the following description and the accompanying drawings.

### BRIEF DESCRIPTION OF THE DRAWINGS

FIG. 1 is a perspective view of an exemplary ladder for a mast assembly in a deployed position, according to an embodiment of the present disclosure;

FIG. 2 is a perspective view of the exemplary ladder for the mast assembly in an intermediate position, according to an embodiment of the present disclosure; and

FIG. 3 is a perspective view of the exemplary ladder for the mast assembly in a collapsed position, according to an embodiment of the present disclosure.

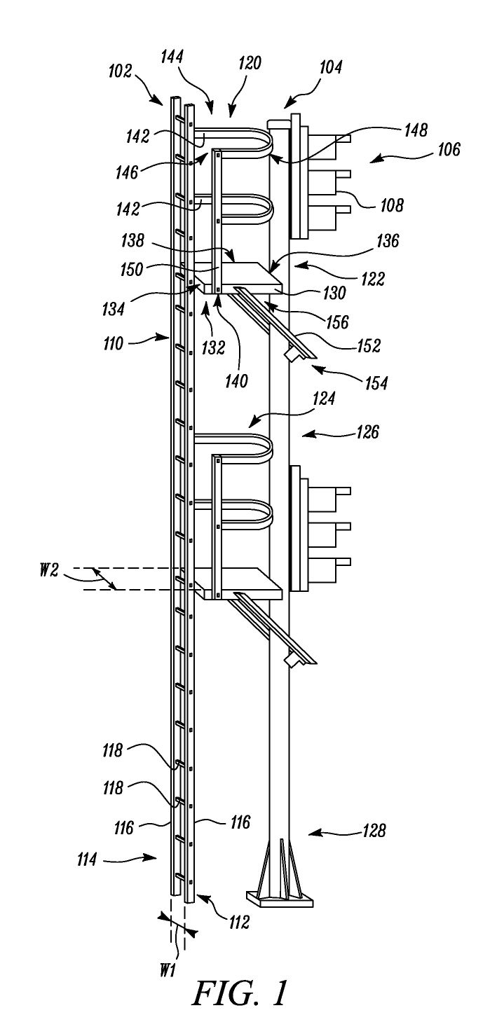

### DETAILED DESCRIPTION

Wherever possible, the same reference numbers will be used throughout the drawings to refer to the same or similar parts. Referring to FIG. 1, a perspective view of an exemplary ladder 102 for a mast assembly 104 is illustrated. More specifically, the ladder 102 is in a deployed position with respect to the mast assembly 104. The ladder 102 and the mast assembly 104 are associated with a railway signal assembly 106. Accordingly, the mast assembly 104 is configured to mount one or more signal lights 108 thereon. In other embodiments, the ladder 102 and the mast assembly 104 may be associated with, but not limited to, a traffic signal assembly, a lighting tower, a watch tower, an air traffic control tower, a radar tower, a telecommunication tower, a radio tower, and a tower crane. Accordingly, the mast assembly 104 may be configured to mount one or more lights, a radar equipment, a telecommunication equipment, as the case may be. The ladder 102 is configured to allow personnel to access various sections of the mast assembly 104 for maintenance and/or operational requirements.

The ladder 102 includes a frame assembly 110. The frame assembly 110 is collapsible against the mast assembly 104. The frame assembly 110 includes an interior facing side 112 and an exterior facing side 114. The frame assembly 110 is configured to be coupled to the mast assembly 104. The frame assembly 110 includes a pair of side rails 116. Each of the pair of side rails 116 is parallel to one another. Each of the pair of side rails 116 has a rectangular cross section (not shown). In other embodiments, each of the pair of side rails 116 may have a triangular cross section, a circular cross section, an elliptical cross section, an I-shaped cross section, a T-shaped cross section, and so on. Further, the frame assembly 110 includes a plurality of rungs 118 having a width “W1”. Each of the plurality of rungs 118 extends between the pair of side rails 116. Each of the pair of rungs 118 is parallel to one another. Further, each of the plurality of rungs 118 is perpendicular to the plurality of side rails 116. Each of the plurality of rungs 118 is configured to enable the personnel to access the ladder 102.

The ladder 102 also includes at least one sub-assembly. The at least one sub-assembly is collapsible against the mast assembly 104. The at least one sub-assembly is affixed to the interior facing side 112 of the frame assembly 110. More specifically, the ladder 102 includes a first sub-assembly 120 affixed to an upper section 122 of the ladder 102. Additionally or optionally, the ladder 102 includes a second sub-assembly 124 affixed to a middle section 126 of the ladder 102. In other embodiments, the ladder 102 may include a third sub-assembly (not shown) affixed to a lower section 128 of the ladder 102. In yet other embodiments, the ladder 102 may include only one or additional sub-assemblies at any section of the ladder 102 as per system design and requirements. For the purpose of explanation, the at least one sub-assembly will now be explained with reference to the first sub-assembly 120. It should be noted that the second sub-assembly 124, the third sub-assembly and/or other additional sub-assemblies may be configured in a manner similar to the first sub-assembly 120.

The first sub-assembly 120 includes a platform 130. The platform 130 is provided at a bottom section 132 of the first sub-assembly 120. The platform 130 is configured to provide support to the personnel while on the first sub-assembly 120 during operational and/or maintenance activity. The platform 130 includes a first end 134, a second end 136, a third end 138, and a fourth end 140. The first end 134 defines a width “W2”. The width “W2” of the first end 134 is greater than the width W1” of each of the plurality of rungs 118. The first end 134 is pivotally coupled to the frame assembly 110. More specifically, the first end 134 is pivotally coupled to one of the pair of side rails 116 on the interior facing side 112 of the frame assembly 110. The second end 136 is pivotally coupled to the mast assembly 104.

Further, the first sub-assembly 120 includes a plurality of support rails 142. The plurality of support rails 142 is provided at a top section 144 of the first sub-assembly 120. More specifically, the plurality of support rails 142 includes two support rails 142 spaced apart from one another. In other embodiments, the first sub-assembly 120 may include only one support rail 142 or multiple support rails 142. The plurality of support rails 142 are provided on at least one of the third end 138 and the fourth end 140 of the platform 130. Each of the plurality of support rails 142 includes a first end 146 and a second end 148. The first end 146 of each of the plurality of support rails 142 is pivotably coupled to a vertical support member 150.

The vertical support member 150 is provided on the first end 134 of the platform 130. More specifically, one vertical support member 150 is provided each of the opposing sides of the first end 134. The vertical support member 150 is pivotally coupled to the platform 130. In some embodiments, the vertical support member 150 may be omitted. In such a situation, the first end 146 of each of the plurality of support rails 142 may be pivotably coupled to one of the pair of side rails 116 on the interior facing side 112 of the frame assembly 110. In other embodiments, the first end 146 of each of the plurality of support rails 142 may be left uncoupled. The second end 148 of each of the plurality of support rails 142 is pivotally coupled to the mast assembly 104.

The ladder 102 also includes a bracket 152. The bracket 152 has a U-shaped configuration. The bracket 152 includes a first end 154 and a second end 156. The bracket 152 is pivotally coupled to the mast assembly 104 at the first end 154. The second end 156 of the bracket 152 is configured to engage with the platform 130 and provide support thereon, in the deployed position of the first sub-assembly 120 with respect to the mast assembly 104. Alternatively, in other embodiments, the ladder 102 may include one or more support rods (not shown). One end of the support rod may be pivotally coupled to the mast assembly 104. Another end of the support rod may be configured to engage with the platform 130 and provide support thereon in the deployed position of the first sub-assembly 120 with respect to the mast assembly 104.

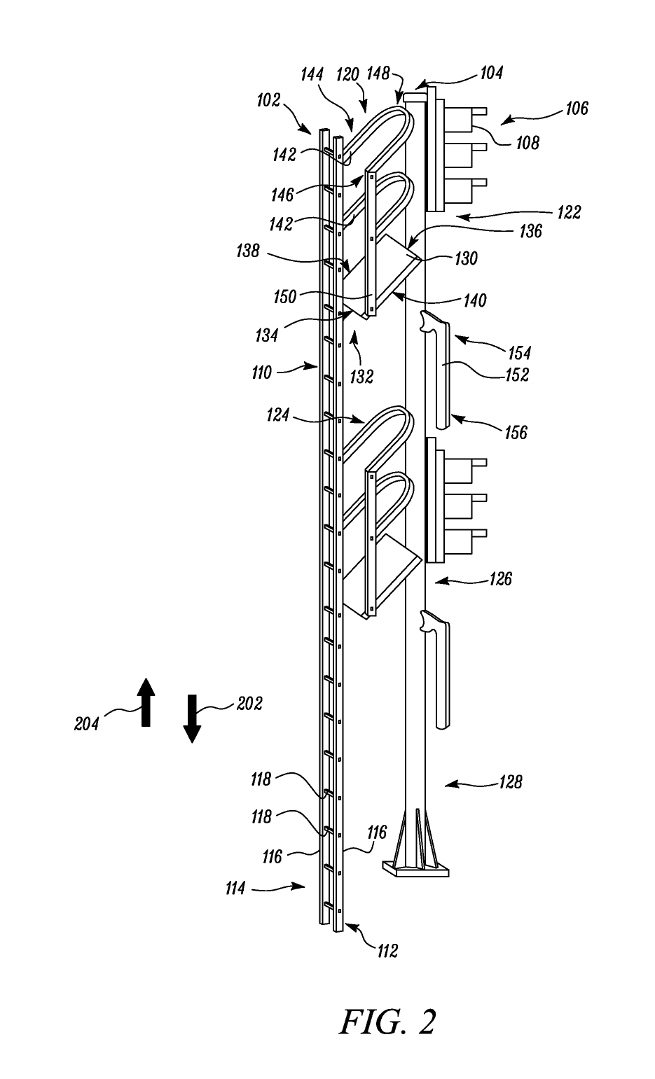

Referring to FIG. 2, a perspective view of the ladder 102 in an intermediate position with respect to the mast assembly 104 is illustrated. The intermediate position may represent a position of the ladder 102 when the ladder 102 may move from the deployed position to a collapsed position and vice versa. In the intermediate position, the bracket 152 is disengaged from the platform 130. When the ladder 102 may move from the deployed position to the collapsed position, the frame assembly 110 and the first and second sub-assemblies 120, 124 move in a downward direction as shown by an arrow 202. As a result, the frame assembly 110 moves downward with respect to the mast assembly 104. Accordingly, a ground surface may include a trough (not shown) to receive the lower section 128 of the frame assembly 110 in the intermediate or collapsed position of the ladder 102. Also, in the intermediate position, the frame assembly 110 moves closer to the mast assembly 104 as compared to the deployed position illustrated in FIG. 1.

It should be noted that, in other embodiments, when the ladder 102 moves from the deployed position to the collapsed position, the ladder 102 may move in an upward direction as shown by an arrow 204. Accordingly, the frame assembly 110 and the first and second sub-assemblies 120, 124 may move in the upward direction as shown by the arrow 204.

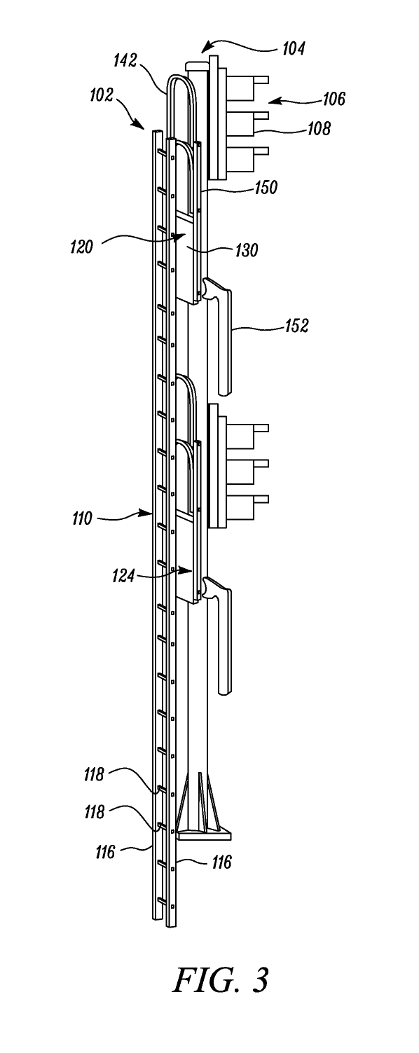

Referring to FIG. 3, a perspective view of the ladder 102 in the collapsed position with respect to the mast assembly 104 is illustrated. In the collapsed position, the first and second sub-assemblies 120, 124 contact and rest against the mast assembly 104, Also, the frame assembly 110 moves further closer to the mast assembly 104 in the collapsed position of the ladder 102 as compared to the intermediate position illustrated in FIG. 2. It should be noted that connections between the frame assembly 110, the first sub-assembly 120, the second sub-assembly 124, and/or components therebetween may alternatively be any known coupling, such as, a hinged coupling configured to allow movement in one direction.

### INDUSTRIAL APPLICABILITY

The present disclosure relates to the ladder 102 and the mast assembly 104 for railway applications. One or more railway signal lights 108 may be mounted thereon. The ladder 102 may provide access to various locations on the mast assembly 104, such as, during maintenance of the railway signal lights 108, associated electrical components, and so on. The ladder 102 is collapsible with respect to the mast assembly 104. As such the ladder 102 may be collapsed and folded against the mast assembly 104 when unused or during transportation, thus reducing space occupied by the ladder 102 and the mast assembly 104. Further, the ladder 102 may include one or more sub-assemblies 120, 124 for access to various locations on the mast assembly 104 for maintenance and/or operational purposes. The sub-assemblies 120, 124 may also collapse and fold against the mast assembly 104 when unused. The sub-assemblies 120, 124 may include one or more support rails 142 to provide support to the personnel. Further, the ladder 102 may be collapsed in any of the downward direction and the upward direction, as shown by the arrow 202 and the arrow 204 respectively.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A ladder for a mast assembly, the ladder comprising:
a frame assembly configured to be coupled to the mast assembly, the frame assembly including:
a pair of side rails; and
a plurality of rungs extending between the pair of side rails; and
at least one sub-assembly affixed to an interior facing side of the frame assembly, the at least one sub-assembly comprising:
a platform provided at a bottom section of the sub-assembly, wherein a first end of the platform is pivotably coupled to the frame assembly, and a second end of the platform is pivotably coupled to the mast assembly; and
a plurality of support rails provided at a top section of the sub-assembly, each of the plurality of support rails being spaced apart from each other, wherein a first end of each of the support rails is pivotably coupled to the frame assembly and a second end of each of the support rails is configured to contact with the mast assembly when the ladder is in a deployed position with respect to the mast assembly,
wherein the frame assembly and the at least one sub-assembly is collapsible against the mast assembly.

2. The ladder of claim 1 further comprising a vertical support member, wherein the vertical support member is pivotably connected to the plurality of support rails and the platform.

3. The ladder of claim 1, wherein the at least one sub-assembly includes a first sub-assembly provided at an upper section of the ladder and a second sub-assembly provided at a middle section of the ladder.

4. The ladder of claim 1 further comprising a bracket pivotably coupled to mast assembly, the bracket configured to engage with the ladder when the ladder is in the deployed position.

5. The ladder of claim 4, wherein the bracket has a U- shape.

6. The ladder of claim 1, wherein the plurality of support rails is provided on both sides of the platform.

7. The ladder of claim 1, wherein a width of each of the plurality of rungs is lesser than a width of the platform.

8. A railway signal assembly comprising:
a mast assembly;
a ladder having an interior facing side connected to the mast assembly, the ladder comprising:
a frame assembly configured to be coupled to the mast assembly, the frame assembly including:
a pair of side rails; and
a plurality of rungs extending between the pair of side rails; and
at least one sub-assembly affixed to the interior facing side, the at least one sub-assembly comprising:
a platform provided at a bottom section of the sub-assembly, wherein a first end of the platform is pivotably coupled to the frame assembly, and a second end of the platform is pivotably coupled to the mast assembly; and
a plurality of support rails provided at a top section of the sub-assembly, each of the plurality of support rails being spaced apart from each other, wherein a first end of each of the support rails is pivotably coupled to the frame assembly and a second end of each of the support rails is configured to contact with the mast assembly when the ladder is in a deployed position with respect to the mast assembly,
wherein the frame assembly and the at least one sub-assembly is collapsible against the mast assembly.

9. The railway signal assembly of claim 8 further comprising a vertical support member, wherein the vertical support member is pivotably connected to the plurality of support rails and the platform.

10. The railway signal assembly of claim 8, wherein the at least one sub-assembly includes a first sub-assembly provided at an upper section of the ladder and a second sub-assembly provided at a middle section of the ladder.

11. The railway signal assembly of claim 8 further comprising a bracket pivotably coupled to mast assembly, the bracket configured to engage with the ladder when the ladder is in the deployed position.

12. The railway signal assembly of claim 11, wherein the bracket has a U-shape.

13. The railway signal assembly of claim 8, wherein the plurality of support rails is provided on both sides of the platform.

14. The railway signal assembly of claim 8, wherein a width of each of the plurality of rungs is lesser than a width of the platform.
